(19) United States
(12) Patent Application Publication
(10) Pub. No.: US 2008/0093970 A1
(43) Pub. Date: Apr. 24, 2008

(54) Electrode for a high-intensity discharge lamp

(75) Inventors: Pavel Pekarski, Aachen (DE); Holger Moench, Vaals (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,834

(22) PCT Filed: Jul. 5, 2005
(86) PCT No.: PCT/IB05/52236

§ 371 Date: Jan. 9, 2007

(30) Foreign Application Priority Data
Jul. 9, 2004 (EP) 04103274.9

(51) Int. Cl. H01J 61/073

(52) U.S. Cl. 313/326

(57) ABSTRACT

The invention relates to an electrode for a high-intensity discharge lamp, at least consisting of an electrode head (7) and an electrode base (5), wherein at least one region of the electrode base (5) has a lower thermal conductivity than the electrode head (5) and/or at least one element designed for limiting the heat flow in the electrode base is arranged between the electrode head and the electrode base.

The invention relates to an electrode for a high-intensity discharge lamp, at least consisting of an electrode head and an electrode base.

High-intensity discharge lamps (HID lamps) and particularly UHP (ultra high performance) lamps are preferably used inter alia for projection purposes on account of their optical properties. Within the context of the invention, the term UHP lamp (Philips) also encompasses UHP-type lamps made by other manufacturers.

High-intensity discharge lamps usually comprise two such electrodes. These electrodes are often arranged opposite one another in a discharge space located in the lamp tube. The electrodes have an electrode head at one end and the electrode base at the other end. Within the context of the invention, the electrode head and the electrode base may be arranged in one component, for example in a rod-shaped electrode, or in a number of components. The electrode base is connected to the lamp tube, which is usually made of quartz or hard glass.

The discharge space of the high-intensity discharge lamp is hermetically sealed and filled in particular with an inert gas. Between the tips of the electrodes, which lie opposite one another, an arc discharge is produced in the discharge space, wherein the arc serves as the light source of the high-intensity discharge lamp.

Energy is introduced through the internal electrodes, which are preferably made of tungsten. The electrodes are usually connected to an external ballast via molybdenum. The molybdenum is usually formed as a molybdenum foil or tape and molybdenum wire. The gas-tight closure is usually formed by at least one gas-tight seal between the glass-type material, usually quartz, and molybdenum. The seal may be designed in a known manner as a so-called pinch seal or molybdenum foil seal. Since the thermal expansion coefficients of quartz glass and molybdenum are very different, shrinkage of the molybdenum in the seal is unavoidable in the event of considerable temperature fluctuations. The gas-tight sealing of the seal is ensured by the dimensioning of the molybdenum, particularly the molybdenum foil, and of the seal.

The service life of the lamp is influenced inter alia by the fact that, during operation of the lamp, material is removed in the region of the electrode base. This is caused in particular by the operating temperature of approximately 1800 to 2200 K which prevails there.

By virtue of thermal conduction, heat is also transferred into the region of the seal of the lamp tube which serves to fix the electrode to the lamp. Undesirable recrystallization of the quartz material of this region, particularly in the seal or the so-called pinch, cannot be ruled out.

In order to reduce the transfer of heat into the seal, it would in principle be possible to minimize the size of the electrode base for a given maximum lamp power. However, one limit in this respect is formed by the required mechanical stability, which must be ensured even when handling and transporting the lamp.

On the other hand, when increasing the maximum lamp power for application purposes, an increase in the size of the electrode base is usually also necessary, and this results in an undesirable increase in terms of heat transfer.

In order to cool the electrodes, usually a tungsten wire is wound tightly around the electrode one or more times. The cooling effect of this solution is limited and cannot be used for every application.

EP 0756312A2 discloses an electrode having a cooling body for cooling the tip of the electrode. The cooling body is made of a high-melting metal material and is fixedly connected to the electrode by means of a powder metallurgy process. Cooling of the tip of the electrode is said to be achieved by virtue of optimized thermal conduction.

It is an object of the invention to provide an electrode for high-intensity discharge lamps of the type mentioned above and a corresponding high-intensity discharge lamp with an improved service life, which limits the transfer of heat into the electrode base and into the seal of the high-intensity discharge lamp.

The object of the invention is achieved by the features of claim 1.

It is essential to the invention here that at least one region of the electrode base has a lower thermal conductivity than the electrode head and/or at least one element which limits the heat flow in the electrode base is arranged between the electrode head and the electrode base.

By virtue of the solution according to the invention, the operating temperature of the lamp can be significantly reduced in the electrode base and in the seal of the high-intensity discharge lamp.

Moreover, by virtue of the reduced thermal conductivity according to the invention in at least one region of the electrode base, a reduced heat transfer per unit time takes place in the region of the seal of the lamp tube. The risk of undesirable recrystallization of the quartz material of this region, particularly in the seal, is thus completely or partially prevented.

The electrode head and the tip thereof consist of the customary electrode materials, are in particular designed to be solid and may be shaped differently, for example in a cylindrical, conical or spherical manner. The aforementioned list is not definitive within the context of the invention.

The parts of the electrode, such as the electrode head and the electrode base, are fixedly connected to one another by methods known per se or in a manner known per se. Use may be made for example of known methods of welding or laser technology. Individual, several or all parts may be produced together or produced separately and connected to one another.

It is preferred that at least one region of the electrode base has design features such that the thermal conductivity there is lower than in the electrode head. Account should be taken here of the thermodynamic aspects, such as cylindrical, which are known per se. Design measures which bring about improved cooling, in particular by virtue of improved conditions for heat transfer, such as for example the arrangement of cooling ribs, may independently thereof be advantageous within the context of the invention.

Besides design features, this also relates to the choice of materials with regard to their physical properties, such as the density. A different density distribution over the cross section of the electrode may also be preferred in this respect.

A porosity or particle size, for example in the case of materials which are produced by means of a powder metallurgy process, for example a sintering process, may likewise be preferred in this respect.

By virtue of a further embodiment of the invention, it is preferred that the element is arranged between the electrode head and the electrode base such that these do not directly touch one another. By virtue of this embodiment, the heat flow must take place via the element, so that the intended limitation of the heat flow, or of the thermal conductivity within the context of the invention, is ensured.

The element may have both design features and physical features in the aforementioned sense such that the thermal conductivity there is lower than that in the electrode head. The element in particular fulfills the function of the mechanical connection, wherein the necessary mechanical stability has to be ensured; however, it may additionally fulfill other functions. One of these additional functions may be for example the cooling function, so that in this case the amount of heat which is transferred from the element to the electrode base is significantly smaller than the amount of heat coming towards the element from the electrode head.

It is particularly preferred that the element is a cooling element, preferably a wound wire or a cylindrical body, which consists in particular of a material produced by means of a powder metallurgy process.

It is furthermore preferred that the cylindrical element is shaped such that its outer surface promotes the dissipation of heat, for example by heat radiation, and/or its inner surface limits the flow of heat towards the electrode base.

It is additionally preferred that, in or on the region of the electrode base which is subject to increased material removal during operation of the lamp, there is an additional material reservoir in the form of a cross-sectional expansion and/or an additionally arranged cylindrical body. The additional material reservoir may be an integral component of the electrode base, for example in the form of a cross-sectional expansion, or be an additional component which is subsequently fixed to the electrode base. The material reservoir is preferably arranged at the point where there is a risk of material being removed on account of the above-described temperature conditions. The size of the material reservoir is preferably dimensioned inter alia as a function of the desired service life of the electrode as a whole.

The object of the invention is moreover achieved by a high-intensity discharge lamp having the features of claim 10 and by a projection system having the features of claim 11.

The invention will be further described with reference to examples of embodiments shown in the drawings to which, however, the invention is not restricted.

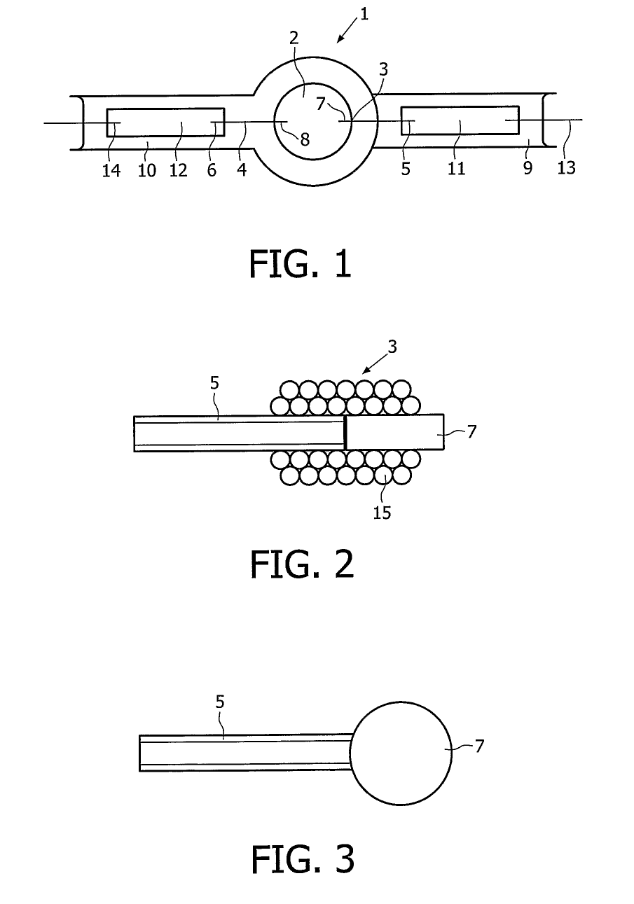

FIG. 1 shows a schematic sectional view of a lamp tube of a high-intensity discharge lamp (UHP lamp) comprising an electrode arrangement.

FIG. 2 shows a schematic sectional view of one embodiment of an electrode according to the invention.

FIG. 3 shows a schematic sectional view of an alternative embodiment (compared to FIG. 2) of an electrode according to the invention.

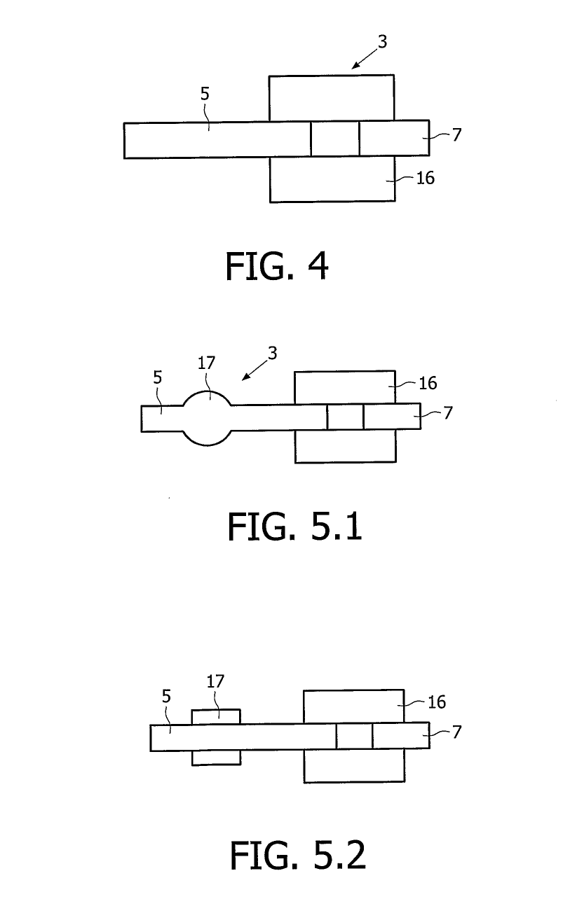

FIG. 4 shows a schematic sectional view of a further embodiment of an electrode according to the invention.

FIG. 5 shows a schematic sectional view of an electrode according to the invention which comprises a material reservoir.

FIG. 1 schematically shows a sectional view of a lamp tube 1 with a discharge space 2 of a high-intensity discharge lamp (UHP lamp) known from the prior art. The lamp tube 1, which is made in one piece and is usually made of quartz glass and hermetically seals a discharge space 2 filled with a conventional gas, comprises two cylindrical regions of the seals 9, 10 which lie opposite another and between which there is an essentially spherical region having a diameter of approximately 10 mm. The electrode arrangement comprises essentially a first electrode 3 and a second electrode 4, between the opposite electrode heads 7, 8 of which an arc discharge is produced in the discharge space 2, wherein the arc serves as the light source of the high-intensity discharge lamp. The other ends of the electrodes 3, 4, that is to say the electrode bases 5, 6, are connected to the molybdenum wires 13, 14 via the molybdenum tapes 11, 12. The molybdenum wires 13, 14 are also connected to the electrical terminals of the lamp (not shown in FIG. 1), via which the supply voltage required to operate the lamp is fed by a power supply, possibly with a ballast, designed for a general mains voltage.

The electrodes 3, 4 mainly consist of a tungsten material, are of cylindrical shape and are approximately 4 to 8 mm long, and the electrode bases 5, 6 have a diameter of approximately 0.3 to 0.7 mm.

FIG. 2 shows one embodiment of an electrode 3 according to the invention. The electrode base 5 is shaped as a hollow cylinder, wherein its outer diameter is approximately 0.6 mm and its inner diameter is approximately 0.3 mm. The electrode base 5 consists of a tungsten material produced by means of a powder metallurgy process, so that the electrode base 5 has a lower density than the electrode head 7. This tungsten material of the electrode base 5 may be produced for example in a conventional sintering process from tungsten powder having a particle size of approximately 0.4 to 30 μm, wherein the shape of a hollow cylinder is achieved by extrusion. One end of the electrode base 5 is fixedly connected to the electrode head 7, which electrode head is solid and made of tungsten and is of cylindrical shape. In order to cool the electrode 3, a tungsten wire 15 is wound tightly around the electrode 3 a number of times in a known manner.

At least one such electrode according to the invention can be used in high-intensity discharge lamps, in particular UHP lamps, which can be used in a system for projection purposes.

FIG. 3 shows an alternative embodiment to FIG. 2, wherein this once again has the above-described electrode base 5 and a different electrode head 7. This electrode head 7 is spherical and solid and made of tungsten.

The electrode head 7 may be designed and produced for example in accordance with U.S. Pat. No. 6,552,499 B2.

FIG. 4 shows a further embodiment of an electrode 3 according to the invention. The electrode 3 has an electrode base 5 and a solid electrode head 7, wherein at least one element 16 which limits the heat flow in the electrode base is arranged between the electrode head 7 and the electrode base 5. The electrode base 5 and the electrode head 7 are fixedly connected to one another by the element 16, wherein they do not directly touch one another. The element 16, which in this case is a cooling element, is shaped as a hollow cylinder and consists of a tungsten material produced by means of a powder metallurgy process, so that the cooling element has a lower density than the electrode head 7.

The cooling element could alternatively be a wound wire which is fixedly connected to the electrode base 5 and the electrode head 7 and ensures the necessary mechanical stability of the electrode 3.

The electrode base 5 may be solid or hollow, or have at least one region which has a lower thermal conductivity than the electrode head 7.

This electrode head 7 may be cylindrical or spherical and preferably consists of solid tungsten.

FIG. 5 shows in a schematic sectional view an electrode 3 according to the invention which comprises a material reservoir 17 in the region of the electrode base 5.

The electrode 3 is in principle designed in the same way as shown in FIG. 4, but additionally has at least one material reservoir 17. This material reservoir 17 in the form of a cross-sectional expansion or an additionally arranged cylindrical body (component) is arranged in (FIG. 5.1) or on (FIG. 5.2) the region of the electrode base 5 which is subject to increased material removal during operation of the lamp.

1. An electrode for a high-intensity discharge lamp, at least consisting of an electrode head (7) and an electrode base (5), characterized in that at least one region of the electrode base (5) has a lower thermal conductivity than the electrode head (7) and/or at least one element (16) designed for limiting the heat flow in the electrode base (5) is arranged between the electrode head (7) and the electrode base (5).

2. An electrode as claimed in claim 1, characterized in that at least one region of the electrode base (5) has design features such that the thermal conductivity there is lower than in the electrode head (7).

3. An electrode as claimed in claim 2, characterized in that at least one region of the electrode base (5) is cylindrical.

4. An electrode as claimed in claim 1, characterized in that at least one region of the electrode base (5) has physical features such that the thermal conductivity there is lower than in the electrode head (7).

5. An electrode as claimed in claim 4, characterized in that at least one region of the electrode base (5) has a lower density than the electrode head (7), wherein this region consists in particular of a material produced by means of a powder metallurgy process.

6. An electrode as claimed in claim 1, characterized in that an element (16) is arranged between the electrode head (7) and the electrode base (5) such that these do not directly touch one another.

7. An electrode as claimed in claim 1, characterized in that the element (16) is a cooling element, preferably a wound wire or a cylindrical body, which consists in particular of a material produced by means of a powder metallurgy process.

8. An electrode as claimed in claim 7, characterized in that the cylindrical element (16) is shaped such that its outer surface promotes the dissipation of heat and/or its inner surface limits the flow of heat towards the electrode base (5).

9. An electrode as claimed in claim 1, characterized in that, in or on the region of the electrode base (5) which is subject to increased material removal during operation of the lamp, there is an additional material reservoir (17) in the form of a cross-sectional expansion and/or an additionally arranged cylindrical body.

10. A high-intensity discharge lamp comprising at least one electrode as claimed in claim 1.

11. A projection system comprising at least one lamp as claimed in claim 10.
